(19) United States
(12) Patent Application Publication
(10) Pub. No.: US 2014/0213243 A1
(43) Pub. Date: Jul. 31, 2014

(54) SERVICE EQUIPMENT CONTROL METHOD AND USER EQUIPMENT FOR PERFORMING THE SAME

(71) Applicant: Electronics & Telecommunications Research Institute, Daejeon (KR)

(72) Inventors: Jong Hyouk Noh, Daejeon (KR); Seok Hyun Kim, Jeollanam-do (KR); Seung Hyun Kim, Daejeon (KR); Soo Hyung Kim, Daejeon (KR); Sang Rae Cho, Daejeon (KR); Dae Seon Choi, Daejeon (KR); Young Seob Cho, Daejeon (KR); Jin Man Cho, Daejeon (KR); Seung Hun Jin, Daejeon (KR)

(73) Assignee: Electronics & Telecommunications Research Institute, Daejeon (KR)

(21) Appl. No.: 14/065,196

(22) Filed: Oct. 28, 2013

(30) Foreign Application Priority Data
Jan. 30, 2013 (KR) 10-2013-0010689

(51) Int. Cl. H04L 12/28

(52) U.S. Cl. CPC H04L 12/2816
USPC 455/419

(57) ABSTRACT

Disclosed is a service equipment control method for easily controlling a plurality of pieces of service equipment with one application. The service equipment control method includes requesting control interface information, used for controlling control target service equipment, from the control target service equipment, receiving the control interface information from the control target service equipment in response to the request, and outputting the received control interface information to a user. Accordingly, it is not necessary to install a home gateway, and a plurality of pieces of control target service equipment can be controlled using one application without needing to install an application for individual service equipment for controlling the service equipment.

### CLAIM FOR PRIORITY

This application claims priority to Korean Patent Application No. 10-2013-0010689 filed on JAN 30, 2013 in the Korean Intellectual Property Office (KIPO), the entire contents of which are hereby incorporated by reference.

### BACKGROUND

1. Technical Field

Example embodiments of the present invention relate in general to home automation technology and more specifically to a service equipment control method for controlling a plurality of pieces of service equipment without a separate home gateway and user equipment for performing the same.

2. Related Art

Generally, a home network denotes that various pieces of service equipment (for example, electronic devices) in the home configure one network. By using such a home network, a plurality of pieces of service equipment can be simultaneously controlled even remotely without needing to manipulate the service equipment at a short distance.

Moreover, home automation is technology for remotely controlling and monitoring a plurality of pieces of service equipment using the home network.

Such home automation technology includes schemes of connecting service equipment to a home gateway and connecting the home gateway to user equipment, thereby controlling the service equipment.

Therefore, the home automation technology connects service equipment, user equipment, and a home gateway to the Internet to control the service equipment.

The purpose of the home gateway is to reduce a burden in which user equipment separately accesses a variety of service equipment. This is because a dedicated application for individual service equipment is needed for user equipment accessing individual service equipment separately.

The home gateway has an advantage in that a plurality of pieces of service equipment are grouped, but has a problem in that separate connection work is required between service equipment and the home gateway, for which wireless Internet is used.

Moreover, whenever new service equipment is added, the new service equipment should be connected to the home gateway, and when the new service equipment is not a product manufactured by the same company, a connection between the home gateway and the new service equipment or between the new service equipment and user equipment can be impossible.

### SUMMARY

Accordingly, example embodiments of the present invention are provided to substantially obviate one or more problems due to limitations and disadvantages of the related art.

Example embodiments of the present invention provide a service equipment control method for controlling a plurality of pieces of service equipment without a separate home gateway.

Example embodiments of the present invention also provide user equipment for performing a service equipment control method that controls a plurality of pieces of service equipment without a separate home gateway.

In some example embodiments, a service equipment control method, which is performed in an application installed in user equipment, includes: requesting control interface information, used for controlling control target service equipment, from the control target service equipment; receiving the control interface information from the control target service equipment in response to the request; and outputting the received control interface information to a user.

The service equipment control method may further include, after the outputting of the received control interface information, transmitting a control command, selected from the output control interface information, to the control target service equipment on the basis of a user input signal.

The service equipment control method may further include: before the requesting of control interface information, finding at least one or more pieces of service equipment near the user equipment to output the at least one or more found pieces of service equipment; receiving selection of control target service equipment from among the at least one or more output pieces of service equipment on the basis of input information; and performing a communication connection with the control target service equipment.

The service equipment control method may further include, before the requesting of control interface information, performing a communication connection with the control target service equipment using near field communication (NFC) technology.

The performing of the communication connection may include, when information on the communication connection with the control target service equipment is stored, performing the communication connection with the control target service equipment on the basis of the stored communication connection information.

The service equipment control method may further include, after the performing of the communication connection, storing at least one of the information on the communication connection with the control target service equipment and information on the service equipment.

The outputting may include: generating an interface screen, used for receiving a control command for the control target service equipment from the user, on the basis of the received control interface information; and outputting the generated interface screen.

The control interface information may include an image.

The control interface information may be composed of hypertext markup language (HTML).

The application of the user equipment may include an HTML parser, the HTML to parser generating the interface screen on the basis of the control interface information.

In other example embodiments, a service equipment control method, which is performed in service equipment, includes: receiving a control interface information request, used for controlling the service equipment, from user equipment; obtaining control interface information corresponding to the control interface information request; and transmitting the obtained control interface information to the user equipment.

The service equipment control method may further include: after the transmitting of the obtained control interface information, when a control command for controlling the service equipment is received, performing a service corresponding to the received control command; and transmitting a control performance response to the user equipment in response to the control command.

The control interface information may include an image.

The control interface information may be composed of HTML.

The service equipment control method may further include: before the receiving of a control interface information request, performing a communication connection with the user equipment; and storing at least one of the information on the communication connection with the user equipment and information on the user equipment.

The performing of a communication connection may include: receiving a communication connection request from the user equipment; and when the information on the communication connection with the user equipment is stored, performing the communication connection with the user equipment using the stored communication connection information.

In still other example embodiments, user equipment includes: a communicator configured to perform communication; a protocol processor configured to request control interface information from control target service equipment through the communicator, and perform control to output the control interface information, received from the control target service equipment, to a user through the communicator; and an interface configured to output the received control interface information on the basis of control by the protocol processor.

The protocol processor may find at least one or more pieces of service equipment near the user equipment through the communicator to output the at least one or more found pieces of service equipment through the interface, receive selection of control target service equipment from among the at least one or more output pieces of service equipment, and perform a communication connection with the control target service equipment through the communicator.

The protocol processor may generate an interface screen used for receiving a control command from the user, on the basis of the received control interface information, and output the generated interface screen through the interface.

The control interface information may include an image.

When the information on the communication connection with the control target service equipment is stored in a storage, the protocol processor may obtain the communication connection information from the storage, and perform a communication connection with the control target service equipment through the communicator on the basis of the obtained communication connection information.

### BRIEF DESCRIPTION OF DRAWINGS

Example embodiments of the present invention will become more apparent by describing in detail example embodiments of the present invention with reference to the accompanying drawings, in which:

FIG. 1 is a conceptual diagram illustrating an operating environment in which a service equipment control method according to an embodiment of the present invention is performed;

FIG. 2 is a flowchart illustrating a service equipment control method according to an embodiment of the present invention;

FIG. 3 is a flowchart illustrating a service equipment control method according to an embodiment of the present invention which is performed in user equipment;

FIG. 4 is a flowchart illustrating an operation performed before operation S360 of FIG. 3;

FIG. 5 is a flowchart for specifically describing an operation of performing a communication connection with control target service equipment in FIG. 4;

FIG. 6 is a flowchart illustrating a service equipment control method according to an embodiment of the present invention which is performed in service equipment;

FIG. 7 is a flowchart for specifically describing an operation of performing a communication connection with user equipment in FIG. 6;

FIG. 8 is a block diagram illustrating a configuration of the user equipment that performs the service equipment control method according to an embodiment of the present invention; and

FIG. 9 is a block diagram illustrating a configuration of the service equipment that performs the service equipment control method according to an embodiment of the present invention.

### DESCRIPTION OF EXAMPLE EMBODIMENTS

Since the present invention may have diverse modified embodiments, preferred embodiments are illustrated in the drawings and are described in the detailed description of the invention.

However, it should be understood that the particular embodiments are not intended to limit the present disclosure to specific forms, but rather the present disclosure is meant to cover all modifications, similarities, and alternatives which are included in the spirit and scope of the present disclosure.

Relational terms such as first, second, and the like may be used for describing various elements, but the elements should not be limited by the terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

In the following description, the technical terms are used only for explaining a specific exemplary embodiment while not limiting the present disclosure. The terms of a singular form may include plural forms unless referred to the contrary. The meaning of “comprise,” “include,” or “have” specifies a property, a region, a fixed number, a step, a process, an element and/or a component but does not exclude other properties, regions, fixed numbers, steps, processes, elements and/or components.

Unless terms used in the present disclosure are defined differently, the terms may be construed as meaning known to those skilled in the art. Terms such as terms that are generally used and have been in dictionaries should be construed as having meanings matched with contextual meanings in the art. In this description, unless defined clearly, terms are not ideally, excessively construed as formal meanings.

Embodiments of the present invention will be described below in more detail with reference to the accompanying drawings. In describing the invention, to facilitate the entire understanding of the invention, like numbers refer to like elements throughout the description of the figures, and a repetitive description on the same element is not provided.

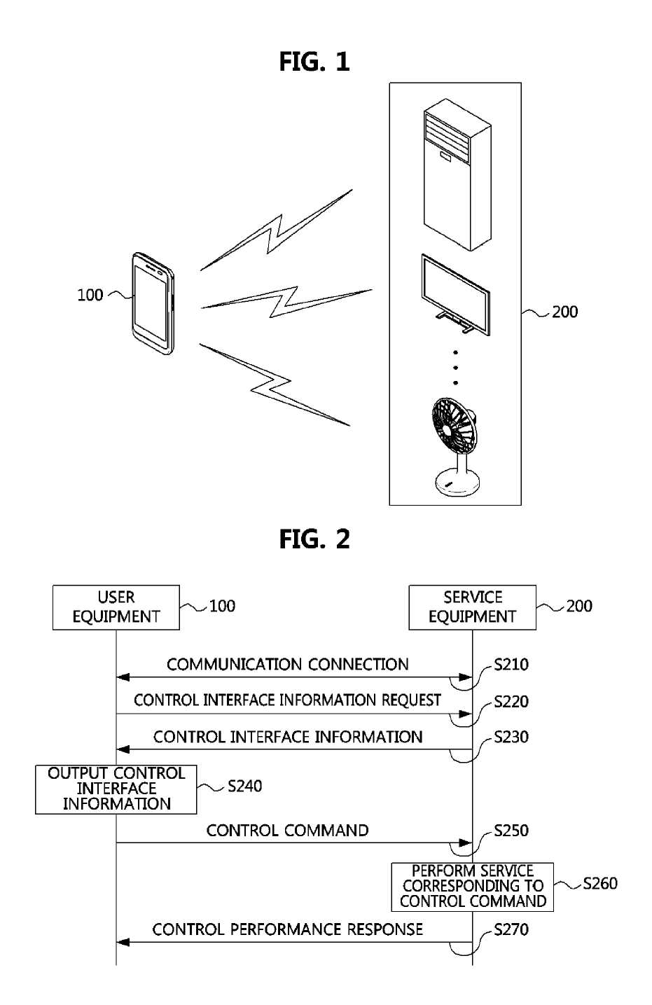

FIG. 1 is a conceptual diagram illustrating an operating environment in which a service equipment control method according to an embodiment of the present invention is performed.

Hereinafter, it is assumed that a client application for performing a service equipment control method is previously installed in user equipment 100 according to an embodiment of the present invention.

Referring to FIG. 1, an application of the user equipment 100 may perform a communication connection with service equipment 200, and control the communication-connected service equipment 200.

Here, the service equipment 200 may include, for example, electronic products, such as an air conditioner, a television (TV), an electric fan, etc., and a large screen, a kiosk, a digital signage, etc. which are installed in a public place.

Here, the user equipment 100 may be referred to as user equipment (UE), a mobile station (MS), a user terminal (UT), a wireless terminal, an access terminal (AT), a terminal, a subscriber unit, a subscriber station (SS), a wireless device, a radio communication device, a wireless transmit/receive unit (WTRU), a mobile node, a mobile, or other terms.

Moreover, various embodiments of the user equipment 100 may include a cellular phone, a smart phone having a radio communication function, a personal digital assistant (PDA) having a radio communication function, a wireless modem, a portable computer having a radio communication function, a capturing device such as a digital camera having a radio communication function, a game device having a radio communication function, a music storage and replay appliance having a radio communication function, an Internet appliance enabling wireless Internet access and browsing, and a terminal or a portable unit having a combination of the functions, but the present invention is not limited thereto.

In the related art, it is required to install a home gateway for controlling the service equipment 200 with the user equipment 100, or to install an application for controlling a plurality of pieces of the service equipment 200 in each piece of service equipment 200.

However, according to the service equipment control method according to an embodiment of the present invention, a plurality of pieces of service equipment may be controlled using one application, and it is not required to install a separate home gateway.

Hereinafter, a service equipment control operation in which an application of user equipment controls service equipment according to an embodiment of the present invention will be described. Also, an operation performed in the service equipment when the application of the user equipment controls the service equipment according to another embodiment of the present invention will be described.

FIG. 2 is a flowchart illustrating a service equipment control method according to an embodiment of the present invention.

Referring to FIG. 2, an application installed in the user equipment 100 performs a communication connection with the service equipment 200 in operation S210.

Here, communication between the application installed in the user equipment 100 and the service equipment 200 may be performed using various wireless communication technologies such as IEEE 802.11x (for example, 802.11a, 802.11b, 802.11g, 802.11n, 802.11ac, etc.), Bluetooth, Zigbee, ultra wide band (UWB), near field communication (NFC), binary code division multiple access (B-CDMA), Long Term Evolution (LTE), WiFi-Direct, etc.

For example, the application installed in the user equipment 100 may perform pairing with the service equipment 200 on the basis of a user input for a Bluetooth-communication connection with the service equipment 200. Also, the application installed in the user equipment 100 may access the service equipment 200 using the NFC technology installed in the user equipment 100 to perform Bluetooth pairing.

Subsequently, when a communication connection is completed through operation S210, the application installed in the user equipment 100 requests control interface information for controlling the service equipment 200 from the service equipment 200 in operation S220.

Here, the control interface information may include control command contents for controlling the service equipment 200. For example, when the service equipment 200 is an electric fan, the control interface information may include information on adjustment of wind strength, adjustment of a wind direction, and adjustment of a timer, and when the service equipment 200 is a TV, the control interface information may include information on changing of a channel, adjustment of sound volume, input of a channel, and on/off of a power source. When the service equipment 200 is a beam projector, the control interface information may include information on adjustment of beam brightness and adjustment of a beam angle.

Moreover, the application may perform the above-described procedure to control a plurality of pieces of service equipment other than the service equipment 200. Therefore, the present invention can overcome inconvenience in which a plurality of applications are installed for respective pieces of service equipment and control the respective service equipment conventionally.

When the control interface information request for controlling the service equipment 200 is received through operation S220, the service equipment 200 obtains control interface information corresponding to the control interface information request and transmits the obtained control interface information to the user equipment 100 in operation S230.

Here, the control interface information may include an image of an interface screen itself. Also, the control interface information may be composed to be checked in the application of the user equipment 100. For example, the control interface information may be composed of hypertext markup language (HTML).

Subsequently, the application of the user equipment 100 outputs the control interface information received through operation S230 to a user in operation S240.

Here, the output control interface information may be composed in a type similar to a dedicated remote controller of the service equipment 200. For example, when the service equipment 200 is an electric fan, the control interface information may be composed of wind strength buttons, a rotation button, etc., and when the service equipment 200 is a beam projector, the control interface information may be composed of adjustment of beam brightness, adjustment of a beam angle, etc.

The user equipment 100 transmits a control command, which is selected from the control interface information on the basis of an input signal input from the user, to the service equipment 200 in operation S250.

The service equipment 200 performs a service corresponding to the control command received through operation S250 in operation S260, and transmits a control performance response to the user equipment 100 in response to the control command in operation S270.

Therefore, according to the service equipment control method according to an embodiment of the present invention, it is not necessary to install a home gateway, and a plurality of pieces of service equipment can be controlled using one application.

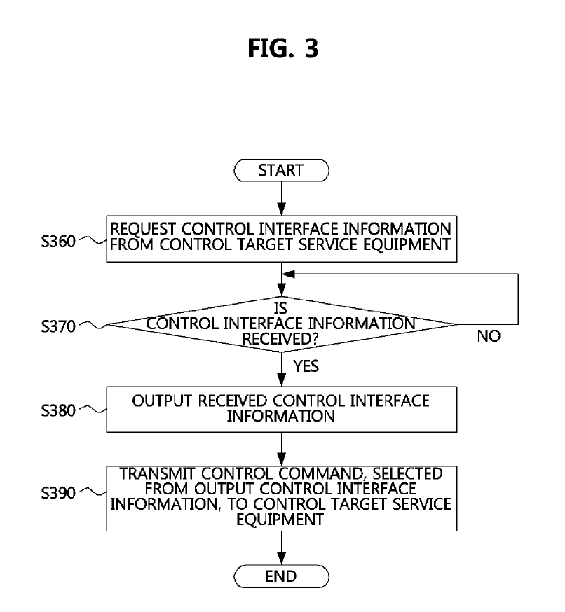

FIG. 3 is a flowchart illustrating a service equipment control method according to an embodiment of the present invention which is performed in user equipment.

Referring to FIG. 3, an application installed in user equipment 100 requests control interface information for controlling control target service equipment 200 from the control target service equipment 200 in operation S360.

Here, the control interface information may include control command contents providable by the control target service equipment 200. For example, when the control target service equipment 200 is an electric fan, the control interface information may include information on adjustment of wind strength, adjustment of a wind direction, and adjustment of a timer, and when the control target service equipment 200 is a TV, the control interface information may include information on changing of a channel, adjustment of sound volume, input of a channel, and on/off of a power source. When the control target service equipment 200 is a beam projector, the control interface information may include information on adjustment of beam brightness and adjustment of a beam angle.

Moreover, the control interface information may be an image including control command contents, and the image may be composed to be analyzed by the application installed in the user equipment 100. For example, the control interface information may be composed of HTML.

Subsequently, the application installed in the user equipment 100 determines whether control interface information corresponding to the control interface information request transmitted through operation S360 is received in operation S370.

When the control interface information is received through operation S370, the application installed in the user equipment 100 outputs the received control interface information so as to enable a user to check the control interface information in operation S380.

Here, the application installed in the user equipment 100 may generate an interface screen for receiving a control command for the control target service equipment 200 on the basis of the received control interface information, and output the generated interface screen to the user.

Moreover, the application installed in the user equipment 100 includes an HTML parser, and when the received control interface information is composed of HTML, the HTML parser may generate and output the interface screen on the basis of the received control interface information.

Moreover, when the received control interface information is an interface screen (i.e., an image) including a control command, the application installed in the user equipment 100 may output the image to the user using a web browser function.

Subsequently, the application installed in the user equipment 100 generates a control command for controlling the control target service equipment 200 on the basis of an input signal input from the user, and transmits the generated control command to the control target service equipment 200 in operation S390.

Therefore, according to the service equipment control method according to an embodiment of the present invention, it is not necessary to install a home gateway, and a plurality of pieces of control target service equipment can be controlled using one application.

FIG. 4 is a flowchart illustrating an operation performed before operation S360 of FIG. 3.

Referring to FIG. 4, the application installed in the user equipment 100 finds service equipment near the user equipment 100 on the basis of an input signal input from the user in operation S310.

Subsequently, the application installed in the user equipment 100 outputs at least one piece of service equipment found through operation S310 in operation S320.

When there is a user input signal in operation S330, the application installed in the user equipment 100 selects control target service equipment 200 from among the at least one or more found pieces of service equipment on the basis of the input signal in operation S340.

Subsequently, the application installed in the user equipment 100 completes a communication connection with the control target service equipment 200 selected through operation S340 in operation S350.

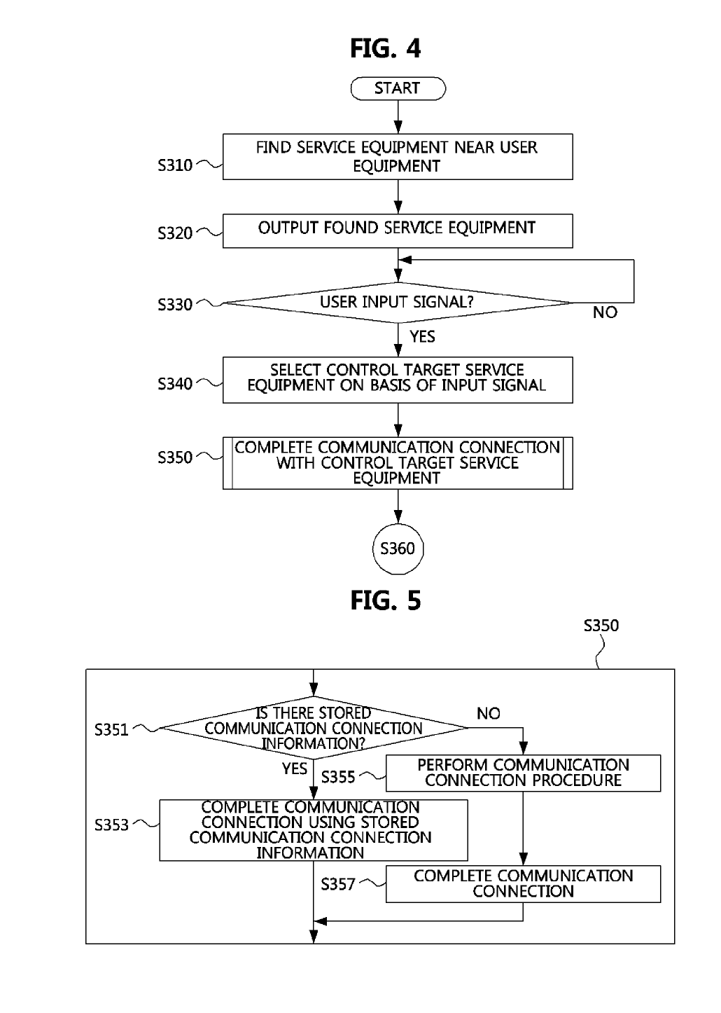

Here, it is possible to perform different procedures according to whether the user equipment 100 stores information on the communication connection with to the control target service equipment 200, and thus operation S350 will be described in detail with reference to FIG. 5.

Therefore, according to the service equipment control method according to an embodiment of the present invention, a plurality of pieces of control target service equipment can be controlled using one application without needing to install an application for each piece of service equipment for controlling the service equipment.

In another embodiment of the present invention, the application installed in the user equipment 100 may complete a communication connection with the control target service equipment 200, and then store the information on the communication connection with the control target service equipment 200 and information on the control target service equipment 200.

FIG. 5 is a flowchart for specifically describing an operation of performing a communication connection with control target service equipment in FIG. 4.

Referring to FIG. 5, when the control target service equipment 200 is selected through operation S340, the application installed in the user equipment 100 determines whether information (for example, Bluetooth pairing information) on a communication connection with the control target service equipment 200 is stored in operation S351.

When the information on the communication connection with the control target service equipment 200 is stored, the application installed in the user equipment 100 completes a communication connection with the control target service equipment 200 using the stored communication connection information in operation S353.

Therefore, when there is the pre-stored communication connection information, the application installed in the user equipment 100 can easily perform a communication connection with the control target service equipment 200.

Alternatively, when the information on the communication connection with the control target service equipment 200 is not stored, the application installed in the user equipment 100 performs a communication connection procedure with the control target service equipment 200 in operation S355, and completes a communication connection with the control target service equipment 200 through the communication connection procedure in operation S357.

Here, when the communication connection with the control target service equipment 200 is completed through operations S355 and S357, the application installed in the user equipment 100 may store information on the communication connection with the control target service equipment 200 for a later communication connection.

Here, the application installed in the user equipment 100 may perform pairing with the control target service equipment 200 to complete a communication connection on the basis of a user input, for a Bluetooth-communication connection.

Alternatively, the application installed in the user equipment 100 may access the control target service equipment 200 using the NFC technology installed in the user equipment 100 to perform Bluetooth pairing, thereby completing a communication connection.

Here, communication between the application installed in the user equipment 100 and the control target service equipment 200 may be performed using various wireless communication technologies such as IEEE 802.11x, Bluetooth, Zigbee, UWB, NFC, B-CDMA, LTE, WiFi-Direct, etc.

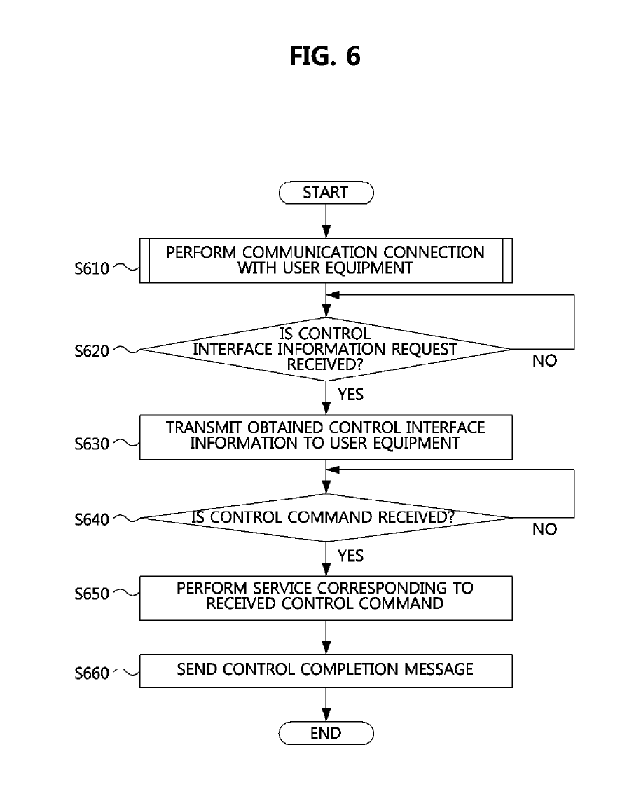

FIG. 6 is a flowchart illustrating a service equipment control method according to an embodiment of the present invention which is performed in service equipment.

Referring to FIG. 6, the service equipment 200 completes a communication connection with the user equipment 100 in operation S610.

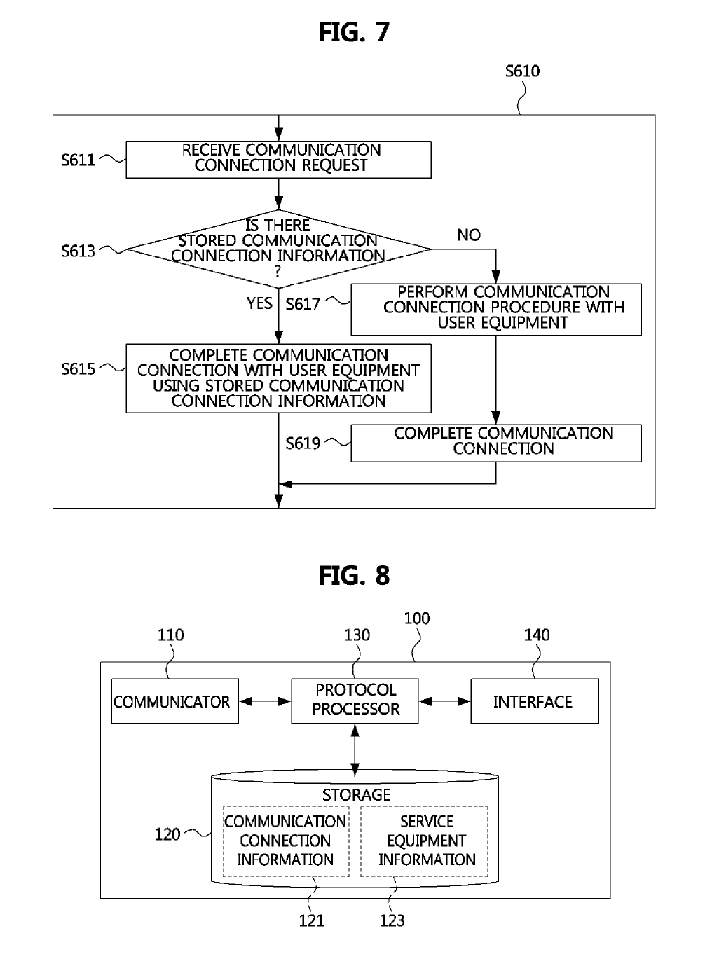

Here, it is possible to perform different procedures according to whether information on the communication connection with the control target service equipment 200 is stored, and thus operation S610 will be described in detail with reference to FIG. 7.

Subsequently, the service equipment 200 determines whether a control interface information request for controlling the service equipment 200 is received from the user equipment 100 in operation S620.

When the control interface information request is received from the user equipment 100 through operation S620, the service equipment 200 obtains control interface information corresponding to the control interface information request and transmits the obtained control interface information to the user equipment 100 in operation S630.

Here, the control interface information may be an interface screen (i.e., an image) including a control command, and the image may be composed in a type capable of being output by a web browser function of the application installed in the user equipment 100. For example, the control interface information may be composed of HTML.

Subsequently, the service equipment 200 determines whether a control command for controlling the service equipment 200 is received from the user equipment 100 in operation S640.

When the control command is received from the user equipment 100 through operation S640, the service equipment 200 performs a service corresponding to the received control command in operation S650.

Here, performing the service corresponding to the received control command denotes, for example, when the service equipment 200 is an electric fan and the received control command includes contents for changing a wind speed, changing a wind speed of the electric fan according to the control command.

The service equipment 200 performs a service corresponding to the control command through operation S650, and transmits a control performance response to the user equipment 100 in response to the control command in operation S660.

Here, operations S650 and S660 preferentially perform an operation of performing a service corresponding to the control command for convenience of description, but may be performed sequentially, in reverse order, or simultaneously. Alternatively, one of the two operations may be not provided.

FIG. 7 is a flowchart for specifically describing an operation of performing a communication connection with user equipment in FIG. 6.

Referring to FIG. 7, when a communication connection request is received from the user equipment 100 in operation S611, the service equipment 200 determines whether information on the communication connection with the user equipment 100 is stored in operation S613.

When the information on the communication connection with the user equipment 100 is pre-stored through operation S613, the service equipment 200 completes a communication connection with the user equipment 100 using the stored communication connection information in operation S615.

Alternatively, when the information on the communication connection with the user equipment 100 is not stored through operation S613, the service equipment 200 performs a communication connection procedure for setting a communication connection with the user equipment 100 in operation S617, and completes a communication connection with the user equipment 100 in operation S619.

Here, when the communication connection with the user equipment 100 is completed through operations S617 and S619, the service equipment 200 may store communication connection information for a later communication connection with the user equipment 100.

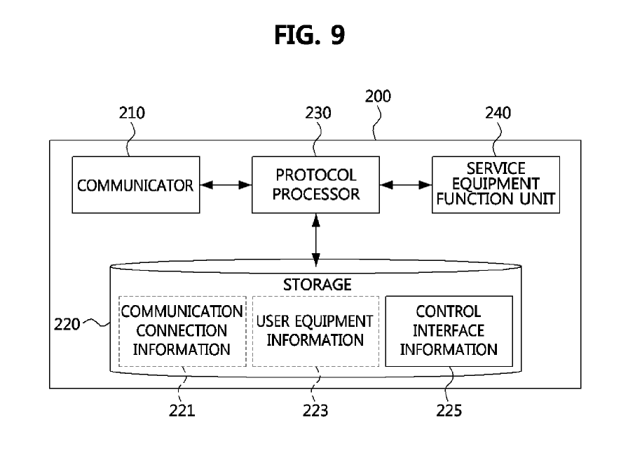

Hereinafter, a configuration of each of the user equipment 100 and service equipment 200 that perform the service equipment control method according to an embodiment of the present invention will be described with reference to FIGS. 8 and 9.

Elements to be described below are elements defined not by physical properties but by functional properties. Thus, each element may be defined by its function. Each element may be implemented as hardware and/or a program code and a processing unit for performing its function. The functions of two or more elements may be implemented to be included in one element.

Accordingly, it should be noted that names of elements in an embodiment to be described below are not given to physically classify the elements but given to imply representative functions performed by the elements, and the technical spirit of the present invention is not limited by the names of the elements.

FIG. 8 is a block diagram illustrating a configuration of the user equipment that performs the service equipment control method according to an embodiment of the present invention.

Referring to FIG. 8, the user equipment 100 according to an embodiment of the present invention may include a communicator 110, a storage 120, a protocol processor 130, and an interface 140.

The communicator 110 communicates with the service equipment 200 on the basis of control by the protocol processor 130. Here, the communicator 110 may communicate with the service equipment 200 using various wireless communication technologies such as IEEE 802.11x, Bluetooth, Zigbee, UWB, NFC, B-CDMA, LTE, WiFi-Direct, etc.

The interface 140 outputs received control interface information to a user on the basis of control by the protocol processor 130.

Moreover, the interface 140 transfers an input signal, input from the user, to the protocol processor 130.

The protocol processor 130 executes a pre-installed application to find at least one piece of service equipment near the user equipment 100 through the communicator 110, and outputs the at least one found piece of service equipment through the interface 140.

Moreover, when a selection input signal for selecting control target service equipment 200 is supplied through the interface 140, the protocol processor 130 determines whether information on the communication connection with the control target service equipment 200 is stored in the storage 120.

When the communication connection information (for example, Bluetooth pairing information) with the control target service equipment 200 is stored in the storage 120, the protocol processor 130 obtains the communication connection information from the storage 120 to complete a communication connection with the control target service equipment 200.

Alternatively, when the information on the communication connection with the control target service equipment 200 is not stored in the storage 120, the protocol processor 130 performs a communication connection procedure with the control target service equipment 200 through the communicator 110, and completes a communication connection with the control target service equipment 200 by performing the communication connection procedure.

For example, the protocol processor 130 may perform pairing with the control target service equipment 200 for a Bluetooth-communication connection with the control target service equipment 200 to complete a communication connection. Alternatively, the application may access the control target service equipment 200 using the NFC technology installed in the user equipment 100 to perform Bluetooth pairing, thereby completing a communication connection.

Moreover, when the communication connection with the control target service equipment 200 is completed, the protocol processor 130 requests control interface information for controlling the control target service equipment 200 from the control target service equipment 200 through the communicator 110.

Here, the control interface information may include control command contents providable by the control target service equipment 200. For example, when the control target service equipment 200 is an electric fan, the control interface information may include information on adjustment of wind strength, adjustment of a wind direction, and adjustment of a timer, and when the control target service equipment 200 is a TV, the control interface information may include information on changing of a channel, adjustment of sound volume, input of a channel, and on/off of a power source. When the control target service equipment 200 is a beam projector, the control interface information may include information on adjustment of beam brightness and adjustment of a beam angle. Also, the control interface information may include an interface screen (i.e., an image) including a control command.

Moreover, when control interface information corresponding to the control interface information request transmitted through the communicator 110 is received, the protocol processor 130 generates an interface screen on the basis of the received control interface information, and outputs the generated interface screen through the interface 140.

Here, the control interface information may be an interface screen, which may be composed of HTML to be analyzed by the application.

Moreover, the protocol processor 130 generates a control command for controlling the control target service equipment 200 on the basis of a user input signal received through the interface 140, and transmits the generated control command to the control target service equipment 200 through the communicator 110.

Therefore, according to the user equipment 100 for controlling service equipment according to an embodiment of the present invention, it is not necessary to install a home gateway, and a plurality of pieces of service equipment can be controlled using one application.

FIG. 9 is a block diagram illustrating a configuration of the service equipment that performs the service equipment control method according to an embodiment of the present invention.

Referring to FIG. 9, the service equipment 200 according to an embodiment of the present invention may include a communicator 210, a storage 220, a protocol processor 230, and a service equipment function unit 240.

First, the communicator 210 communicates with the user equipment 100 on the basis of control by the protocol processor 230. Here, the communicator 210 may communicate with the user equipment 100 using various wireless communication technologies such as IEEE 802.11x, Bluetooth, Zigbee, UWB, NFC, B-CDMA, LTE, WiFi-Direct, etc.

The storage may be configured with a large-capacity nonvolatile storage device (for example, a hard disk drive), and may store communication connection information 221 (for example, Bluetooth pairing information), user equipment information 223 (for example, a name of service equipment, a unique number, and an identification number), control interface information 225, etc.

When a communication connection request is received from the user equipment 100 through the communicator 210, the protocol processor 230 determines whether the communication connection information 221 corresponding to the user equipment 100 is stored in the storage 220.

When the communication connection information 221 corresponding to the user equipment 100 is stored in the storage 220, the protocol processor 230 completes a communication connection with the user equipment 100 through the communicator 210 using the stored communication connection information 221.

Alternatively, when the communication connection information 221 corresponding to the user equipment 100 is not stored in the storage 220, the protocol processor 230 performs a communication connection procedure with the user equipment 100 through the communicator 210 to complete a communication connection with the user equipment 100.

Moreover, when a control interface information request for controlling the service equipment 200 is received from the user equipment 100 through the communicator 210, the protocol processor 230 obtains the control interface information 225 corresponding to the received control interface information request from the storage 220 and transmits the obtained control interface information 225 to the user equipment 100.

Here, the control interface information may be an interface screen (i.e., an image) including a control command, and may be composed of HTML.

Moreover, when a control command for controlling the service equipment 200 is received from the user equipment 100 through the communicator 210, the protocol processor 230 controls the service equipment function unit 240 to perform a service corresponding to the received control command.

Moreover, the protocol processor 230 controls the service equipment function unit 240 to perform the service corresponding to the received control command, and transmits a control performance response to the user equipment 100 through the communicator 210 in response to the received control command.

The service equipment function unit 240 is configured to perform a unique function of the service equipment 200, and performs the unique function of the service equipment 200 on the basis of control by the protocol processor 230.

For example, when the service equipment 200 is an electric fan, the service equipment 200 may turn on/off a power source, adjust wind strength, or adjust a wind direction on the basis of control by the protocol processor 230.

As described above, the service equipment control method and the user equipment for performing the same according to the embodiments of the present invention select a control target service equipment from among a plurality of pieces of service equipment on the basis of an input signal, perform a communication connection with the selected control target service equipment, receive control interface information from the communication-connected control target service equipment, output the received control interface information, and transmit a control command to the control target service equipment to control the control target service equipment on the basis of a user input signal.

Accordingly, it is not necessary to install a home gateway, and a plurality of pieces of service equipment can be controlled by one piece of user equipment instead of a plurality of dedicated pieces of user equipment corresponding to the respective service equipment.

While the example embodiments of the present invention and their advantages have been described in detail, it should be understood that various changes, substitutions and alterations may be made herein without departing from the scope of the invention.

What is claimed is:

1. A service equipment control method, which is performed in an application installed in user equipment, comprising:
requesting control interface information, used for controlling control target service equipment, from the control target service equipment;
receiving the control interface information from the control target service equipment in response to the request; and
outputting the received control interface information to a user.

2. The service equipment control method of claim 1, further comprising transmitting a control command, selected from the output control interface information, to the control target service equipment on the basis of a user input signal.

3. The service equipment control method of claim 1, further comprising:
finding at least one or more pieces of service equipment near the user equipment to output the at least one or more found pieces of service equipment;
receiving selection of control target service equipment from among the at least one or more output pieces of service equipment on the basis of input information; and
performing a communication connection with the control target service equipment.

4. The service equipment control method of claim 3, wherein the performing of the communication connection comprises, when information on the communication connection with the control target service equipment is stored, performing the communication connection with the control target service equipment on the basis of the stored communication connection information.

5. The service equipment control method of claim 3, further comprising, after the performing of a communication connection, storing at least one of the information on the communication connection with the control target service equipment and information on the service equipment.

6. The service equipment control method of claim 1, wherein the outputting comprises:
generating an interface screen, used for receiving a control command for the control target service equipment from the user, on the basis of the received control interface information; and
outputting the generated interface screen.

7. The service equipment control method of claim 6, wherein the control interface information comprises an image.

8. The service equipment control method of claim 6, wherein the control interface information is composed of HTML.

9. The service equipment control method of claim 8, wherein the application comprises an HTML parser, the HTML parser generating the interface screen on the basis of the control interface information.

10. A service equipment control method, which is performed in service equipment, comprising:
receiving a control interface information request, used for controlling the service equipment, from user equipment;
obtaining control interface information corresponding to the control interface information request; and
transmitting the obtained control interface information to the user equipment.

11. The service equipment control method of claim 10, further comprising:
when a control command for controlling the service equipment is received, performing a service corresponding to the received control command; and
transmitting a control performance response to the user equipment in response to the control command.

12. The service equipment control method of claim 10, wherein the control interface information comprises an image.

13. The service equipment control method of claim 10, wherein the control interface information is composed of HTML.

14. The service equipment control method of claim 10, further comprising:
performing a communication connection with the user equipment; and
storing at least one of the information on the communication connection with the user equipment and information on the user equipment.

15. The service equipment control method of claim 14, wherein the performing of a communication connection comprises:
receiving a communication connection request from the user equipment; and
when information on the communication connection with the user equipment is stored, performing the communication connection with the user equipment using the stored communication connection information.

16. A user equipment comprising:
a communicator configured to perform communication;
a protocol processor configured to request control interface information from control target service equipment through the communicator, and perform control to output the control interface information, received from the control target service equipment, to a user through the communicator; and
an interface configured to output the received control interface information on the basis of control by the protocol processor.

17. The user equipment of claim 16, wherein the protocol processor finds at least one or more pieces of service equipment near the user equipment through the communicator to output the at least one or more found pieces of service equipment through the interface, receives selection of control target service equipment from among the at least one or more output pieces of service equipment, and performs a communication connection with the control target service equipment through the communicator.

18. The user equipment of claim 16, wherein the protocol processor generates an interface screen used for receiving a control command from the user, on the basis of the received control interface information, and outputs the generated interface screen through the interface.

19. The user equipment of claim 18, wherein the control interface information comprises an image, or is composed of HTML.

20. The user equipment of claim 17, wherein, when information on the communication connection with the control target service equipment is stored in a storage, the protocol processor obtains the communication connection information from the storage, and performs a communication connection with the control target service equipment through the communicator on the basis of the obtained communication connection information.
